(19) United States
(12) Patent Application Publication
(10) Pub. No.: US 2021/0296967 A1
(43) Pub. Date: Sep. 23, 2021

(54) Motor-Alternator with Simultaneously-Operating Multiple Electric Motors

(71) Applicant: 'SPT BILIG CENTER" LLC, Ulaanbaatar (MN)

(72) Inventors: Dambii Dorligjav, Ulaanbaatar (MN); Dulmaa Bayaraa, Ulaanbaatar (MN)

(73) Assignee: 'SPT BILIG CENTER" LLC, Ulaanbaatar (MN)

(21) Appl. No.: 16/473,596

(22) PCT Filed: Jul. 9, 2018
(86) PCT No.: PCT/IB2018/055026

§ 371 Date: Jun. 25, 2019

(30) Foreign Application Priority Data
Jun. 14, 2018 (MN) 10-2018-0006267

(51) Int. Cl. H02K 11/00; H02K 7/116; H02K 9/06

(52) U.S. Cl. CPC H02K 11/0094; H02K 53/00; H02K 9/06; H02K 7/116

(57) ABSTRACT

This invented electric motor is a new type of motor that is based on a principle in which many of an identical electric motors working at the same power and speed simultaneously to generate combined greater power.

It comprises of a numerous small identical motors (component motors), depending on the output required. These component motors are connected into the main motor along with gears, capacitors and controller units. This motor will generate great amount of power while consuming very small amount of an electricity due to switching of these small component motors to rotate the gears and generate power.

### TECHNICAL FIELD

The invention relates to an electric engine. In particular, this invention relates to an electric engine which converts an electric energy into mechanic energy.

### BACKGROUND ART

Electric motor is a type of device that converts electric energy into mechanical energy in order to generate power. Electric motors can be defined as one of the most important inventions after the discovery of electricity in the field of engineering and technology. Therefore, it is hard to imagine living without electric motors nowadays.

Most electric motors operate through the interaction between motor's magnetic field and winding currents to generate force.

There are two main types of electric motor, DC /direct current/ and AC /alternating current/ motors in terms of electric sources.

AC motors are driven by alternating current. AC motors commonly consist of two basic parts, an outside stator having coils supplied with alternating current to produce a rotating magnetic field, and inside rotor attached to the output shaft producing a second magnetic field.

AC motors are categorized in two main types of motors, Asynchronous/induction/and Synchronous motors.

Synchronous motors depend on the speed of the stator's permanent rotating magnetic field to rotate the rotor inside the motor to generate torque. The speed of synchronous motors magnetic field in the stator can be controlled by the frequency of current that is being supplied to it. Synchronous motors are able to operate at the same speed regardless of the amount of load, as long as the load does not exceed the rated maximum load amount.

Asynchronous motors can be divided into two types as one phase and two phase asynchronous motors. Asynchronous motors always rely on a small difference in speed between the stator rotating magnetic field and the rotor shaft speed to induce rotor current in the rotor AC winding. As a result, it is not able to produce torque near synchronous speed.

DC motors are driven by direct current. It operates with the supply of direct current to the magnetic field creating stator and the rotor windings and generates torque.

There are two types of DC motors, brushed and brushless DC motors. The brushed DC electric motor generates torque directly from DC power supplied to the motor by using internal commutation, stationary magnets and rotating electromagnets. DC motors have low initial cost, simple speed control and high reliability but require high maintenance and have low life-span for high intensity uses.

Both AC and DC motors are widely used throughout the world ranging from industrial uses to ordinary home applications such as fans, refrigerators, pumps, compressors, equipment and so on.

The electric motors that are in use today for many types of applications have greatly contributed to the development of humankind and gave way for many great innovations. But their electricity consumption has risen drastically over the years and the supply of electricity has increased greatly to supply the demand for more electricity, and as a result, it has become a contributor to the global warming issues that we are facing today.

It has therefore become necessary to find a solution to create electricity efficiency without compromising the output capability of electric motors. It has become necessary to create a device or new type of electric motor that consumes less energy to produce the same amount of force that today's electric motors produce.

There are many inventions and solutions that people around the world have come up with to reduce the consumption of electricity in electric motors, but they are mainly focused on increasing efficiency of electric motors and none have come up with a solution to drastically reduce electric motors consumption of electricity.

WO1997032390 discloses High-efficiency electric motor of electronic commutation type. The object of the invention is to achieve the operability of the motor essentially in terms of the waveform of the current absorbed from the battery, while significantly reducing cost and bulk by eliminating the inductance and the switch. As it is not possible to eliminate these components from an operational viewpoint, the invention proposes a solution which utilizes certain switches and certain windings of the ECM, already present for its normal operation, to also perform the function of switch and inductance.

This object is attained according to the invention by a high-efficiency electric motor of electronic commutation type, comprising a single stator unit and a single rotor unit, characterized by comprising a first electrical submachine and a second electrical submachine, in which:
said first submachine is fed by a voltage source and is associated with a sensor for measuring the current absorbed from said feed; said first submachine comprising at least two windings characterized by an inductance, a resistance, an induced electromotive force and a switch connected in series;
   said second electrical machine is fed by a capacitor, which is charged at a controlled voltage.

CN1242642 discloses Energy-saving high efficiency asynchronous electric motor. It is of axial magnetic field type, the rotor is in both ends of the stator, and the air gap is between the rotor and stator which are covered on the axle. The bearing is set between the rotor and the axle. The magnetic current from rotor passes through rotor teeth, air gap, stator teeth, air gap into rotor yoke to form a magnetic circuit. Said design omits the stator yoke needed by traditional radial field type asynchronous motor so that it saves raw material, increases utilization of the material and makes the motor more compact, removes stator yoke cost completely.

KR1020090085718 discloses Electric motor, capable of improving energy efficiency. An electric motor is provided to improve rotation efficiency by reducing reluctance difference between a rotor magnet and a field core. A field magnet is installed in a base of a circular panel of a stator radially. A rotation axis passes through the center of a base. A rotor is combined in the rotation axis. A rotor magnet is arranged between an outer cylinder and an inner cylinder, A cover is combined in the base. A current control apparatus is combined in the rotation axis. The current control apparatus includes a rotation magnet plate and a magnet detection sensor. The magnet detection sensor is arranged in an upper part of the cover. The magnet detection sensor is contacted with the rotation magnet plate. The current control apparatus controls the field magnetization direction of a stator using a rotation angle signal sensed by the magnet detection sensor.

These inventions mainly focus on generating savings through creating efficiency and controlling operation for load amount. Therefore, these do not necessarily create an effective amount of electricity savings for electric motors without losing its capability to handle loads and production of torque.

Therefore, it is important to come up with a solution or to invent electric motor that consumes less energy while keeping the ratio of torque production the same.

### DISCLOSURE OF THE INVENTION

This electric motor that we invented is a new type of motor that is based on a principle in which many of an identical electric motors working at the same power and speed simultaneously to generate combined greater power.

It comprises of a numerous small identical motors (component motors), depending on the output required. These component motors are connected into the main motor along with gears, capacitors and controller units. This motor will generate great amount of power while consuming very small amount of an electricity due to switching of these small component motors to rotate the gears and generate power.

These component motors' combined electricity consumption is equivalent to operating only one of these component motors. Therefore, the sum of power that will be generated from these component motors combined is generated using the amount of electricity equal to only one component motor would consume. Depending on the main motor's load, smart electronic controllers would enable some of the component motors to be used as generators, when they're idle.

It is named as motor-alternator because of its distinction that many small motors operate at the same time with the same power and the same speed to produce combined great power. This type of motor is able to replace all types of internal combustion engines

The main innovative advantage of this motor is that the power generated by this motor is many times greater than the power it consumes.

Another the most innovative advantage of the motor-alternator is that the total electricity consumption by all of the component motors is in many times less than the power being generated by them.

Motor-alternator will always generate equal or considerably more power than the electricity it consumes while all other types of modern motors will always produce equal or less power compared to the energy it consumes.

Another distinctive feature of this motor is that two or more number of small motors working simultaneously, at the same speed, capacity and voltage, transmits power through transmission mechanism to one single shaft while slowing down speed of small motors by at least 1:3 ratio.

To keep motor-alternator's power output stable and not let it lose energy during its switching process, the component motors gets boosted by capacitors.

Motor-alternator's capacitors and batteries are compatible to work with many types of energy sources.

Depending on motor-alternator's load, some of the small motors within motor-alternator gets allocated to function as generators when they're in an idle mode.

The greatest advantage of this motor-alternator is that it generates great amount power from very little amount of electricity.

The component motors are capable of transmitting their rotation movement through all types of transmission mechanisms to the main gear. (chain, gear, worm gear and all types of belt)

Motor-alternator's component motors will all have identical power capacity, identical RPM speed and can be either brushed or brushless, Asynchronous or synchronous AC or DC motors.

The AC component motors and the charging generators can be operable 110 volts or higher, and the capacitors can be supercapacitor, ultracapacitor or simple capacitor.

Motor-alternator's component motors can work by DC battery of above 1 volt. An inverter can be used to increase the voltage above 1 volt.

The generator that feed the component motors are boosted by the capacitors.

The component motors can be AC or DC charging generator and it can be 1-380 volts and higher.

The combined voltage of the capacitors should be 20-25 percent higher than the combined sum of small motors' voltage.

The booster capacitors' discharge level is directly relative to their frequency and charging time.

Power of the motor-alternator is equivalent to the torque it generates, while power generated by typical motor (internal combustion) is less than the torque.

If necessary, the proportion of this motor-alternator can be amplified to the extent that it is theoretically, physically and mechanically possible, motor-alternator can be used by the required amount in order to create even more powerful and efficient motor-alternator. Therefore, motor-alternators are capable of becoming component motor itself for bigger and more powerful motor-alternator and supply unlimited number of continuous component motors with enough power to generate even greater power.

### GENERAL CONSTRUCTION OF THE EMBODIMENT OF THE INVENTION

The motor shaft is located at the center of the motor. The two bearings are located at the front and rear of the motor casing. The small component motors with small gears are placed around the main big gear with the all the small gears connected to the main big gear by their gear teeth.

The charging alternator is placed alongside the small component motors and connected to the main gear and benefits rotation from it.

Behind each of the small component motors there are capacitors that load each of the small motors. The capacitors are capable of being charged by not only the charging alternator, but also by batteries and other sources of electricity.

The capacitor switcher and battery switcher devices are located behind the capacitors at the back of the motor.

All of the component motors will have its own cooling fans and the main cooling big fan is placed on the back of the motor shaft at the back of the motor casing.

There is a segregated lubrication chamber around the gears with gaskets to prevent oil leakage. There is also oil pouring and draining nozzles as well as oil level checking indicator window.

### Embodiment of the Invention

Motor capacitors are sequentially charged by the batteries through capacitor charging device.

The small component motors are supplied with energy from the charged capacitors and starts running.

The component motors' small gears rotate the main gear connected to the main shaft of motor-alternator.

There are 2 bearings at both ends of the shaft to keep the main shaft rotating freely.

The charging alternator starts working and converts the mechanical energy to electrical energy as it is connected to the main gear.

The batteries are charged by the electricity generated from the charging alternator through the battery switcher device.

Torque is generated from the rotational movement of the main shaft /1/ due to interactions between the small gears /5/ that are connected to number of small motors /6/ and the main big gear /4/ which is mounted on the main shaft /1/.

An alternator /18/ that is mounted alongside the small motors /6/ also have a small gear connected to it's shaft and its interaction with the main big gear /4/ enables it to create rotational movement and feed the capacitors /7/ by the electricity it produces.

The charged capacitors /7/ will continuously supply electricity to the many small motors /6/. The capacitors /7/ are charged alternately by switching mechanism.

The capacitors /7/ are mounted at the back wall of the main motor-alternator casing /10/ behind the section containing all the small motors /6/.

The capacitor charging device /8/ is designed for performing the duties of charging the capacitors /7/ alternately in cycle. The capacitor charging device /8/ will be mounted on the wall of the main motor-alternator casing /10/ between the small motors section and back bearing /3/ of the main shaft /1/.

Battery switcher device /9/ is designed to charge the batteries alternately using the electricity generated by the charger alternator /18/.

The main electric motor-alternator has two ways of cooling the small motors /6/ inside it, fan cooling and oil cooling. The fan cooling is done by installing a fan /17/ at the back of the main motor shaft and in front of the shaft's back bearing /3/ and the alternator /18/, small motors /6/ that make up the main motor also has fans /13/ for cooling purposes.

The main motor-alternator's casing /10/ has a section that contains the small gears /4/ and big gears /5/ and it has gaskets /20, 21/ on both sides of the section to prevent oil leakage. This section is also designed to have valves for pouring in /16/ and pouring out /14/ and a small window /15/ to monitor oil levels.

There are small motors gaskets /20/ and alternator gaskets /21/ on the wall /10/ that isolates the gears, between the small gears and the small motors and alternator.

### DESCRIPTION OF DRAWINGS

FIG. 1 shows a component parts
1. Main shaft
2. Shaft key
3. Bearings
4. Big gear
5. Small gear
6. Small motors
7. Capacitor
8. Capacitor charging device
9. Battery switcher device
10. Casing
11. Gaskets
12. Alternator fan
13. Small motors fan
14. Oil pouring-out valve
15. Oil level monitoring window
16. Oil topping up valve
17. Main cooling fan
18. Charging alternator
19. Oil
20. Small motors gasket
21. Charging alternator gasket

FIG. 2—shows a diagram that represent the working principles of the electric motor-alternator

FIG. 3—shows a graph that represent the capacitors charging and discharging points

FIG. 4—shows a diagram that represent the torque levels depending on the rise in temperature

FIG. 5—shows the schematics of the electrical components of the switching devices

FIG. 6—shows the encoder connections

FIG. 7—shows the quantum mechanics formula

FIG. 8—shows the formula for calculating voltage loss period and the capacitor charging optimization.

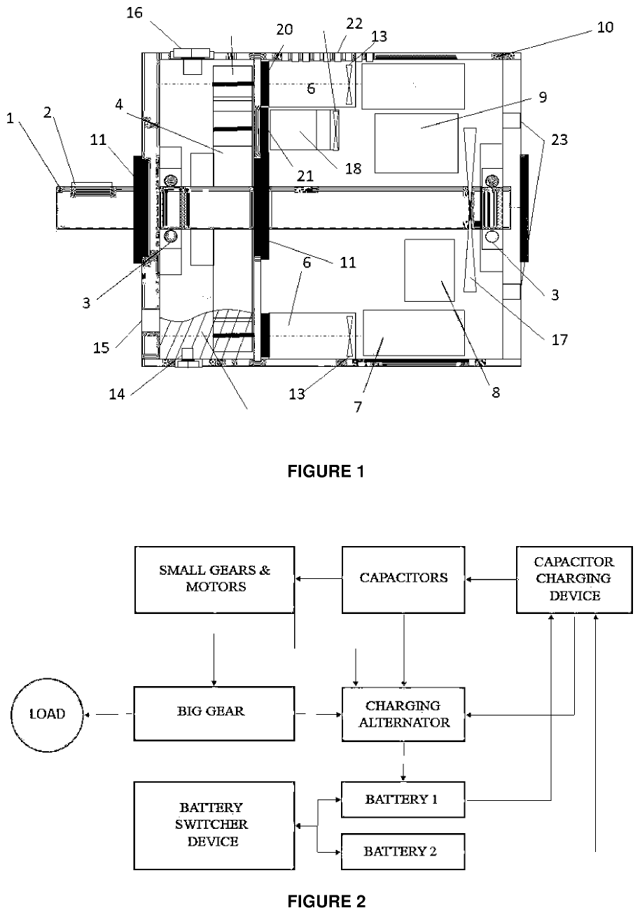

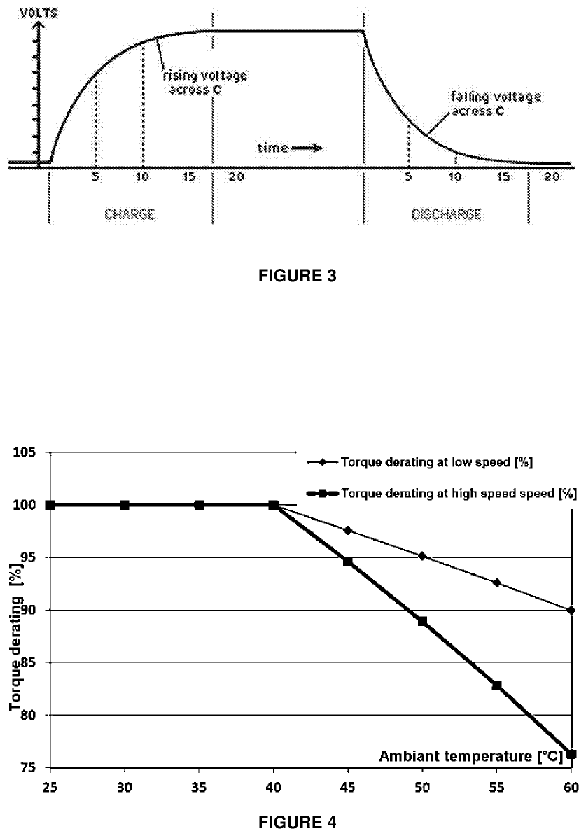

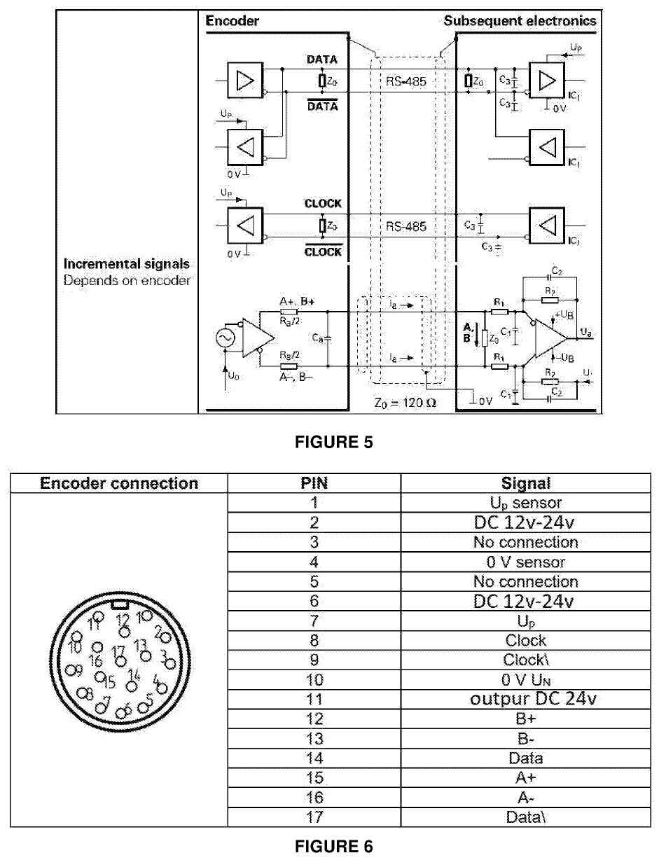

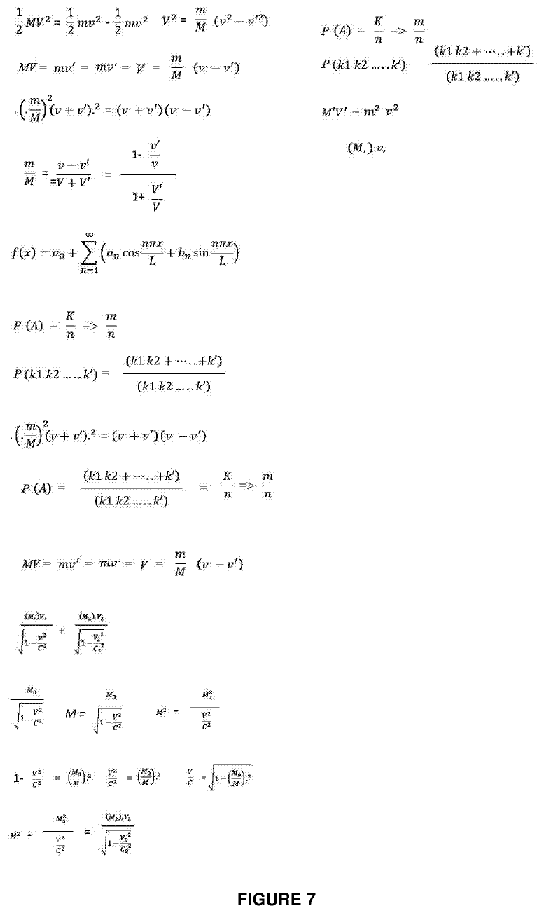

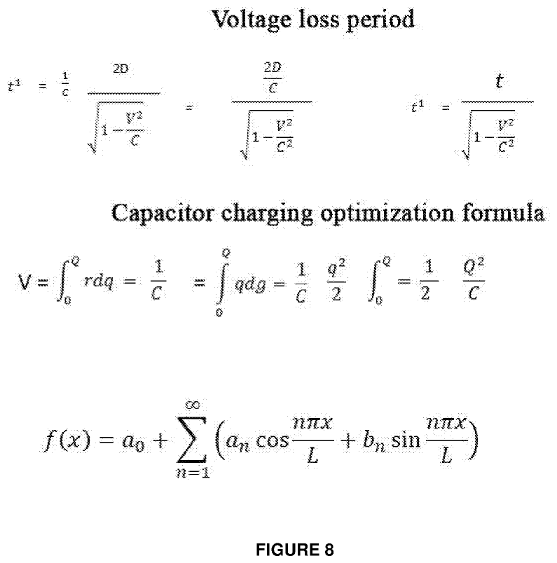

1. Motor-alternator, comprising a multiple electric motors simultaneously operating, wherein two or more motors with the same speed, the same capacity and the same voltage are designed so that to transmit a power working simultaneously, through transmission mechanism to one single shaft while slowing down speed of motors by at least 1:3 ratio and comprising:
a shaft with the main big gear;
a bearings;
a component motors with small gears are placed around the main big gear;
a capacitors;
a charging alternators;
a battery;
a capacitor switcher;
a battery switcher; and
a casing.

2. Motor-alternator according to claim 1, wherein the motor-alternator has a charging alternator located on the main big gear which converts a mechanical energy into electrical energy.

3. Motor-alternator according to claim 1, wherein the motor-alternator has a battery switcher device which charges the batteries switching the electricity generated from the charging alternator.

4. Motor-alternator according to claim 1, wherein the motor-alternator has a capacitor switcher located behind of the motors and between the capacitor and the rear bearing of the main big gear, arranged on the wall of the casing.

5. Motor-alternator according to claim 1, wherein the motor-alternator has a cooling fan fixed at the rear end of the main big gear and front of rear bearing, and each of the motors and alternators has a cooling fan.
